(19) United States
(12) Patent Application Publication
(10) Pub. No.: US 2021/0056948 A1
(43) Pub. Date: Feb. 25, 2021

(54) ACOUSTIC FOCUSING PROBE AND FABRICATION METHOD THEREOF

(71) Applicant: Zhejiang University, Hangzhou (CN)

(72) Inventors: Xu LIANG, Hangzhou (CN); Yongdu RUAN, Hangzhou (CN); Lizhong WANG, Hangzhou (CN); Yuhong WANG, Hangzhou (CN); Titao WANG, Hangzhou (CN); Yu DENG, Hangzhou (CN)

(21) Appl. No.: 16/546,482

(22) Filed: Aug. 21, 2019

(51) Int. Cl. G10K 11/30

(52) U.S. Cl. CPC G10K 11/30

(57) ABSTRACT

An acoustic focusing probe, which is an artificial periodic acoustic structure, including a background material which is water or air, and a plurality of scatterer units in a cross shape. The periodic array structure formed by scatterer units is arranged on the base, and a contour thereof is an ellipse. The present invention is based on the basic principle of controlling acoustic waves by phononic crystal and adopts a new probe structure. Compared to the existing acoustic focusing lens, the acoustic focusing probe of the present invention has a better acoustic focusing effect in various media and a wider range of low and medium frequencies. The probe can focus most of the energy of the acoustic waves to the target area, and thus it can be used in non-invasive ultrasound equipment in the future.

### CROSS-REFERENCE TO RELATED APPLICATIONS

This application claims the benefit of priority from Chinese Patent Application No. CN201810284196.X, filed on Feb. 4, 2018. The content of the aforementioned application, including any intervening amendments thereto, is incorporated herein by reference in its entirety.

### TECHNICAL FIELD

The present application relates to acoustic sensors, more particularly to an acoustic focusing probe and a fabrication method thereof.

### BACKGROUND OF THE INVENTION

Acoustic focusing using the principle of phononic crystal, which is an artificial periodic structure formed by alternate arrangement of two or more different media in space, has been a research focus ever since 2000. The wave number appears periodically in the Brillouin zone when acoustic waves are introduced into a periodic structure, thus changing the propagation characteristics of sound waves to form new features. The propagation of acoustic wave is controlled, for example, by adjusting the material parameters of the phononic crystal, introducing the local resonance, defect mode or geometry change of the scatterer. Therefore, these methods enables new development in vibration and noise reduction, acoustic cloak, super-resolution acoustic imaging and ultrasonic medical treatment, etc.

The phononic crystal with a size much smaller than the working wavelength is also called acoustic metamaterial. Based on the local resonance mechanism, as a new research interest for “controlling of long wavelength by small size”, the acoustic focusing lens, similar to the conventional focusing lens based upon geometrical optics, can be obtained in the range of low and medium frequencies by varying the material parameters and geometry of the phononic crystal.

The fabrication of the acoustic focusing lens has been disclosed in related patents. For example, Chinese Patent Application No. 201510816714.4 discloses a “fabrication method of focusing acoustic Lens”; Chinese Patent Application No. 201610589500.2 discloses a “wide-band acoustic focusing lens based on fractal acoustic metamaterial and fabrication method thereof”. These patents provide a new approach to acoustic focusing, but they have complicated design and are not suitable for various applications, e.g., the application at low frequency.

The acoustic focusing probe, provided by the present invention, can realize the acoustic focusing in a wide range of low frequency and is easy to use in combination with other devices, which provide a new fabrication method of focusing probe in non-invasive ultrasonic equipment.

### SUMMARY OF THE INVENTION

The present invention aims to provide a method for fabricating an acoustic focusing probe which is allowed to be used in a wide range of low frequencies, having an acoustic focusing lens similar to the conventional geometric optical lens.

The present invention provides an acoustic focusing probe, comprising a base and cells, where the cells spaced apart are arranged in a periodic structure on the base, and a contour of a body formed by the cells is an ellipse with a minor axis-to-major axis ratio of 1:1.8˜2.2; and each of the cells comprises a scatterer unit which is a cell body and is periodically arranged on the base and a background material which is a medium for propagating acoustic waves and is filled around the scatter unit.

The background material as a medium for propagating acoustic waves is water or air, which indicates the same effect can be obtained by the acoustic focusing probe in water or air.

Generally, the scatterer unit is made of structural steel or other materials with a high acoustic impedance relative to the background material, and for example, an acoustic impedance of the scatterer unit is at least 25 times larger than an acoustic impedance of the background material. The scatterer unit is of a symmetrical cross shape or an X-shape rotated at a certain angle, and the scatterer units are periodically arranged in a form of a square lattice at a fixed space α. It is should be noted that parameters of all the scatterer units in the same acoustic focusing probe should be consistent.

A height h of the scatterer unit is at least four times greater than a lattice constant α of the cell. The number of the scatterer unit is N which is generally greater than or equal to or slightly less than 263. The enhancement of the effect of the acoustic focusing is not obvious when the number is greater than 263, whereas the attenuation of the effect of the acoustic focusing is apparent if the number is less than 263.

The profile of the body formed by the scatterer units and the background materials of the acoustic focusing probe is the ellipse with a recommended ratio of a major axis to a minor axis of 2:1, and preferably, the range of relative error is within 10% of the recommended ratio.

In some embodiments, the base is used to fix positions of the probe and the scatterer unit.

The present invention provides a method for fabricating the acoustic focusing probe, comprising: selecting the back ground material; designing a shape of the scatterer unit; and preparing the base.

Compared with the prior art, the beneficial effects of the fabrication method provided by the present invention are as follows:

1. In the present invention, the scatterer unit in a cross shape is used for the acoustic focusing probe for the first time, which extends the operating frequency range of the acoustic focusing probe to low and medium frequencies and acoustic waves can be controlled by small size. At the same time, the larger the size of the acoustic focusing probe of the present invention, the longer the controlled wavelength.

2. The acoustic focusing lens with an elliptical contour similar to a geometric optical lens is adopted by the present invention, offering the acoustic focusing probe a wider range of working frequency and the acoustic focusing can also be realized in such frequency range, which provides a new fabrication method for the acoustic focusing probe.

3. Since the entire probe can be made only by one material, the acoustic focusing probe of the present invention is low-cost, easy to fabricate and use, and is able to realize the acoustic focusing in water or air.

### BRIEF DESCRIPTION OF THE DRAWINGS

FIG. 1 is a perspective view of an acoustic focusing probe of the present invention;

FIG. 2 shows a top view and a close-up view of the acoustic focusing probe of the present invention;

FIG. 3 is a schematic diagram of a cell and a scatterer unit;

FIG. 4 is a schematic diagram of the acoustic focusing probe which is focusing acoustic waves;

FIG. 5 is a diagram showing a distribution of absolute sound pressure and contours in a focusing acoustic field;

FIG. 6 is a diagram showing the distribution of the absolute sound pressure along a y-axis at a focal point; and

FIG. 7 is a flow chart of a fabrication process for the acoustic focusing probe of the present invention.

### DETAILED DESCRIPTION OF EMBODIMENTS

The present invention will be further described in detail herein with reference to the embodiments and the accompanying drawings to clarify the object, technical solutions and advantages of the present invention. It should be noted that in the description of the drawings or the specification, the same numerals are used for the same parts. Moreover, although specific parameters are provided in the present invention, it should be understood that the parameters can be approximately equal to the corresponding values within the accepted error range and design constraints rather than being equal to the corresponding values.

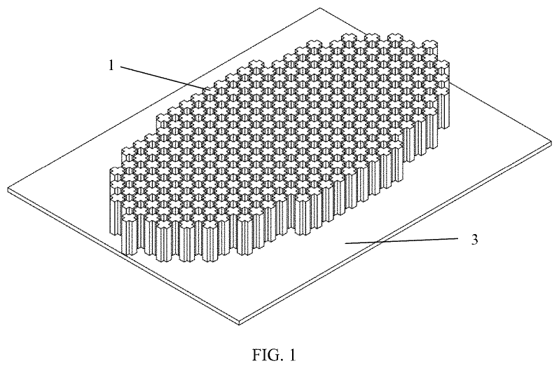

FIG. 1 is a perspective view of an embodiment of an acoustic focusing probe of the present invention. As shown in FIG. 1, the probe comprises a plurality of scatterer units 1, and a base 3 configured for fixing positions of the scatterer units 1. A background material 2, as a medium for propagating acoustic waves, is water or air, which is filled around each of the scatterer units 1. It is indicated that the present invention can produce the same effect in water or air.

The base 3 for fixing the spacing between and positions of the scatterer units is a structural steel plate with a thickness of d which is sufficient to support the structure.

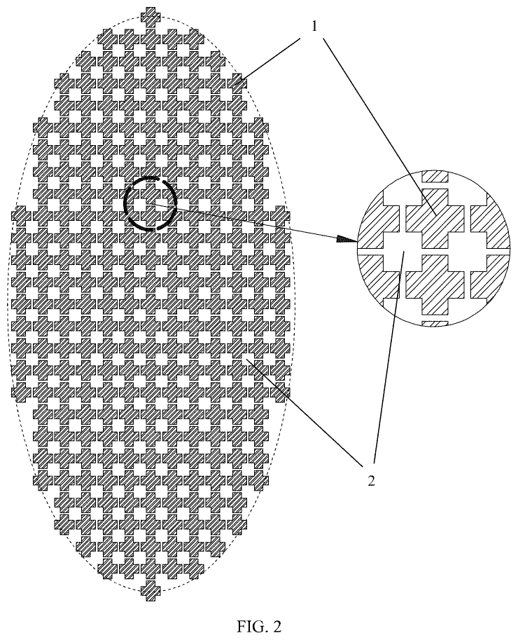

As shown in FIG. 2, the scatterer units 1 and the background material 2 are periodically arranged in a form of a square lattice to constitute a main functional portion of the focusing probe. There are 263 scatterer units 1 which are arranged in an ellipse according to a spacing of lattice constant a, shown by the dashed line in FIG. 2, where the major axis of the ellipse is 520 mm and the minor axis of the ellipse is 260 mm. In the present invention, the area of the ellipse can be resized to appropriately increase or reduce the number of the scatterer units 1 when the major axis-to-minor axis ratio is set to about 2:1.

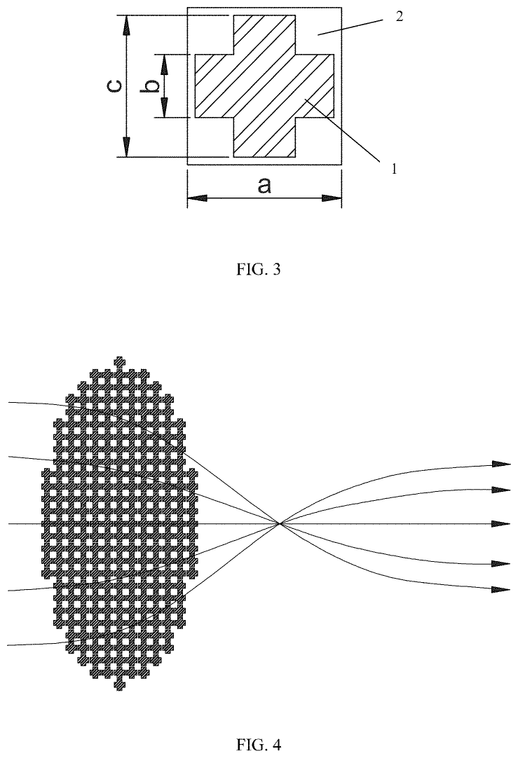

As shown in FIG. 3, the repeat structure comprising the scatterer unit 1 and the background material 2 is referred to as a cell. The scatterer unit, embedded in the cell, is shown in shaded portions in FIGS. 3 and 2, and the blank portion is the background material 2. The scatterer unit 1 is of a symmetric cross shape or an X shape rotated at a certain angle, and it should be noted that the parameters of all the scatterer units 1 in the same acoustic focusing probe should be consistent, for example, the scatterer units 1 are all of a cross shape or an X-shape.

The performance of the acoustic focusing probe will be affected by the structure parameters of the scatterer unit 1. The parameters of the scatterer unit comprise parameters of a, b, c and the rotation angle θ, etc., where a often referred to as the lattice constant of the cell, and the height h of the scatterer unit is at least four times larger than the lattice constant a of the cell. In the present invention, a is 20 mm, b is 8 mm, and c is 18 mm. Alterations of these parameters will change the structure of the energy band of the cell. It should be noted that this is merely an exemplary description, and is not intended to limit the specific shape and structure parameters of the scatterer unit 1 in the present invention.

According to the required operating frequency f, the used frequency of the probe of the present invention can be made to match the required operating frequency f by changing the parameters a, b, c or the angle of the scatterer unit 1.When setting initial parameters, the initial parameters of the scatterer unit 1 can be determined according to the following equations: λ=10a, and b, c≤a. The performance of the probe can be further adjusted by rotating the angle of the scatterer unit 1. Compared to existing focusing lenses, the acoustic focusing probe of the present invention can focus acoustic waves in a range of lower frequencies at the same size and has an optimum operating frequency f₀. When the working frequency of the focusing probe is beyond the operating frequency, that is, dropped to a very low level (i.e., the wavelength is very long), the size of the scatterer unit 1 should be multiplied accordingly to realize the focus of acoustic waves which cannot be realized by only changing the parameters of the scatterer unit 1.

The acoustic focusing probe of the present invention is symmetrical at left and right sides, and both the left side and the right side can be used, and acoustic waves are incident from the minor axis.

The present invention is based on the basic principle of refraction focusing of phononic crystals, as the acoustic waves enter the acoustic focusing probe of the present invention, the acoustic wave energy propagates along the gradient direction in which the characteristic frequency of the scatterer unit 1 changes the most, such that the sound focusing probe of the present invention obtains a relatively wide frequency band when working at low frequencies. The working principle of focusing acoustic waves is depicted in FIG. 4, in which curves and arrows indicate the propagation path of acoustic waves. Plane acoustic waves having a working frequency f is applied to the left (right) end of the focusing probe, and the acoustic waves interact with the scatterer units 1 after passing through the background material 2, and then the acoustic waves are refracted and are focused at a focal point of the right (left) end of the focusing probe.

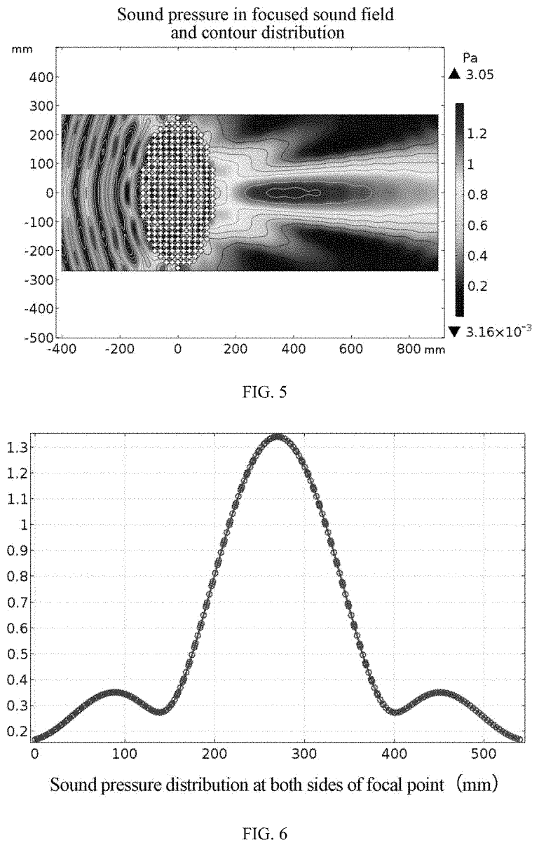

FIG. 5 is a diagram of an absolute sound pressure level and contours around the focusing probe after the acoustic waves generated by the finite element method enter the focusing probe. Corresponding to the working principle shown in FIG. 4, an acoustic focusing phenomenon appears, and a focal point is generated at the right end of the acoustic focusing probe of the present invention. The absolute sound pressure level is the highest at the focal point, and as the distance from the focal point increases, i.e., the focusing probe moves along positive x-axis and y-axis, the absolute sound pressure gradually decreases.

FIG. 6 is a diagram showing the distribution of the absolute sound pressure level at the focus point along y-axis, where the sound pressure value is the largest at a center of the focal point and gradually decreases along both the positive and negative y-axes.

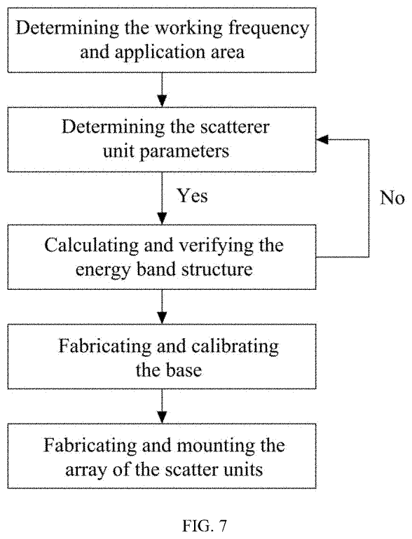

As shown in FIG. 7, a simple and effective fabrication method of the acoustic focusing probe is provided in another embodiment of the present invention, and the related fabrication process is as follows:

Step 1: A target operating frequency range f is selected, and a workplace is selected and the background material is thus selected.

Step 2: According to the wavelength, the shape, number and structure parameters of the scatterer unit 1 are initially determined. The initial parameters of scatterer unit 1 can be determined according to two conditions: the acoustic wavelengths λ=10a, and b, c≤a. Subsequently, the performance of the focusing probe can be further adjusted by rotating the angle of the scatterer unit 1.

Step 3: An energy band structure of the cells obtained in step 2 is determined through a numerical calculation. The working frequency f is determined whether it is within a usable range of the acoustic focusing probe from the energy band structure by comparison, and if not, step 2 is repeated until the working frequency is within the usable range.

Step 4: A base of a suitable size and thickness is fabricated; the position of scatterer unit 1 is determined on the base according to the lattice constant, the structure parameters and the ellipse size; and the base is hollowed out according to the position and structure parameters of the scatterer unit 1 to reserve the mounting position for the scatterer unit 1.

Step 5: The scatterer units 1 in the form of a square lattice are fabricated and periodically arranged into an array; and the array is mounted at the reserved position.

Specifically, under certain conditions, steps 4 and 5 can be combined, for example, the acoustic focusing probe is integrally formed by using a 3D printing technique.

In summary, the present invention provides a method for fabricating the acoustic focusing probe which is capable of focusing acoustic waves in a wide range of low frequencies. The above description is only illustrative rather than limiting the present invention. Any modifications, substitutions and improvements made within the spirit and idea of the present invention shall fall within the scope of the present invention.

We claim:

1. An acoustic focusing probe, comprising: a base and cells;
wherein the cells spaced apart are arranged in a periodic structure on the base, and a contour of a body formed by the cells is an ellipse with a minor axis-to-major axis ratio of 1:1.8˜2.2; and
wherein each of the cells comprises:
a scatterer unit which is a cell body and is periodically arranged on the base; and
a background material which is a medium for propagating acoustic waves and is filled around the scatterer unit.

2. The probe of claim 1, wherein the cells are in a form of a square lattice.

3. The probe of claim 1, wherein the scatterer unit is of a symmetrical cross shape; each of the cells and the scatterer unit thereof have the same center; the scatterer units are arranged in the cells with the same but arbitrary rotation angle; and the scatterer units of respective cells spaced apart are periodically arranged.

4. The probe of claim 2, wherein the scatterer unit is of a symmetrical cross shape; each of the cells and the scatterer unit thereof have the same center; the scatterer units are arranged in the cells with the same but arbitrary rotation angle; and the scatterer units of respective cells spaced apart are periodically arranged.

5. The probe of claim 1, wherein a height of the scatterer unit is at least four times larger than a lattice constant of the cell.

6. The probe of claim 3, wherein a height of the scatterer unit is at least four times larger than a lattice constant of the cell.

7. The probe of claim 1, wherein the background material is water or air.

8. The probe of claim 1, wherein an acoustic impedance of the scatterer unit is at least 25 times larger than an acoustic impedance of the background material.

9. A method for fabricating the probe of claim 1, comprising:
1) selecting a target operating frequency range f, and selecting a workplace, thus selecting the background material;
2) determining shape, number and structure parameters of the scatterer unit according to a wavelength;
3) determining an energy band structure of the cells obtained in step 2 through a numerical calculation; determining whether the working frequency f is within a usable range of the acoustic focusing probe from the energy band structure by comparison; and if not, returning to step 2 until the working frequency f is within the usable range;
4) preparing a base; determining a position of the scatterer unit on the base according to the lattice constant, the structure parameters and the size of ellipse; and hollowing out the base according to the position and structure parameters of the scatterer unit to reserve a mounting position for the scatterer unit; and
5) fabricating and arranging the scatterer units in the form of a square lattice periodically into an array; and mounting the array to the reserved mounting position.
